(19) United States
(12) Patent Application Publication
(10) Pub. No.: US 2023/0283914 A1
(43) Pub. Date: Sep. 7, 2023

(54) Vehicle Event Monitoring Assembly

(71) Applicant: Bryan Boehmer, Silver Springs, NV (US)

(72) Inventor: Bryan Boehmer, Silver Springs, NV (US)

(21) Appl. No.: 17/686,066

(22) Filed: Mar. 3, 2022

(51) Int. Cl. H04N 5/247; H04N 5/232; H04N 7/18; G01P 13/00; G01S 13/931; G01P 15/00; G01C 19/00; B60R 21/0132; B60R 21/015

(52) U.S. Cl. CPC H04N 5/247; H04N 5/23238; H04N 7/183; G01P 13/00; G01S 13/931; G01P 15/00; G01C 19/00; B60R 21/0132; B60R 21/01512

(57) ABSTRACT

A vehicle event monitoring assembly for detecting and imaging events in and around a vehicle includes a plurality of cameras and a plurality of detectors, which are engageable to interior elements and exterior elements of the vehicle, and which are operationally engaged to a communications and control module, which is engageable to the vehicle. A passenger compartment and a 360° area around the vehicle are substantially viewable by the plurality of cameras. The detectors can detect a rollover of the vehicle, motion within or occupancy of the passenger compartment and a trunk, and approach and impact of a second vehicle. The detectors signal the communications and control module of events within and proximate to the vehicle, positioning the communications and control module to actuate the cameras. The communications and control module transmits images and parameters of the events to a base station.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to monitoring assemblies and more particularly pertains to a new monitoring assembly for detecting and imaging events in and around a vehicle. The present invention discloses a monitoring assembly comprising a plurality of cameras for capturing images and a plurality of detectors, which detect events in and around the vehicle.

### (2) Description of Related Art Including Information Disclosed Under 37 CFR 1.97 and 1.98

The prior art relates to monitoring assemblies. Prior art monitoring assemblies comprise cameras and detectors for detecting and imaging events. What is lacking in the prior art is a monitoring assembly comprising a sensor for detecting movement within the vehicle coupled with a panoramic camera and backseat area cameras for capturing images within a passenger compartment of the vehicle.

### BRIEF SUMMARY OF THE INVENTION

An embodiment of the disclosure meets the needs presented above by generally comprising a plurality of cameras and a plurality of detectors, which are configured to be engageable to interior elements and exterior elements of a vehicle, and a communications and control module, which is configured to be engageable to the vehicle. A passenger compartment and a 360° area around the vehicle are substantially viewable by the plurality of cameras. The detectors are configured for one or more of detecting a rollover of the vehicle, motion within or occupancy of the passenger compartment and a trunk of the vehicle, and approach and impact of a second vehicle. The communications and control module is operationally engaged to the detectors and the cameras. The detectors are enabled to signal the communications and control module of events within and proximate to the vehicle, positioning the communications and control module to actuate the cameras. The communications and control module is configured to transmit images and parameters of the events to a base station.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle event monitoring assembly according to an embodiment of the disclosure.

FIG. 2 is an in-use view of an embodiment of the disclosure.

FIG. 3 is an in-use view of an embodiment of the disclosure.

FIG. 4 is a flow diagram of an embodiment of the disclosure.

FIG. 5 is an in-use view of an embodiment of the disclosure.

### DETAILED DESCRIPTION OF THE INVENTION

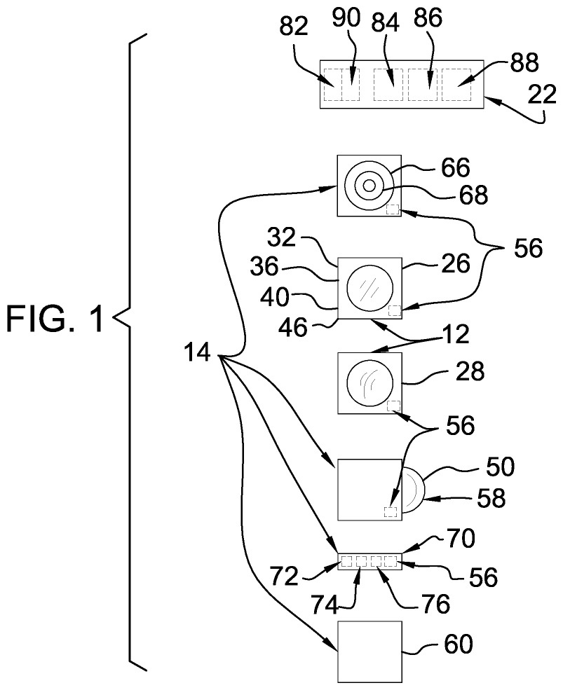

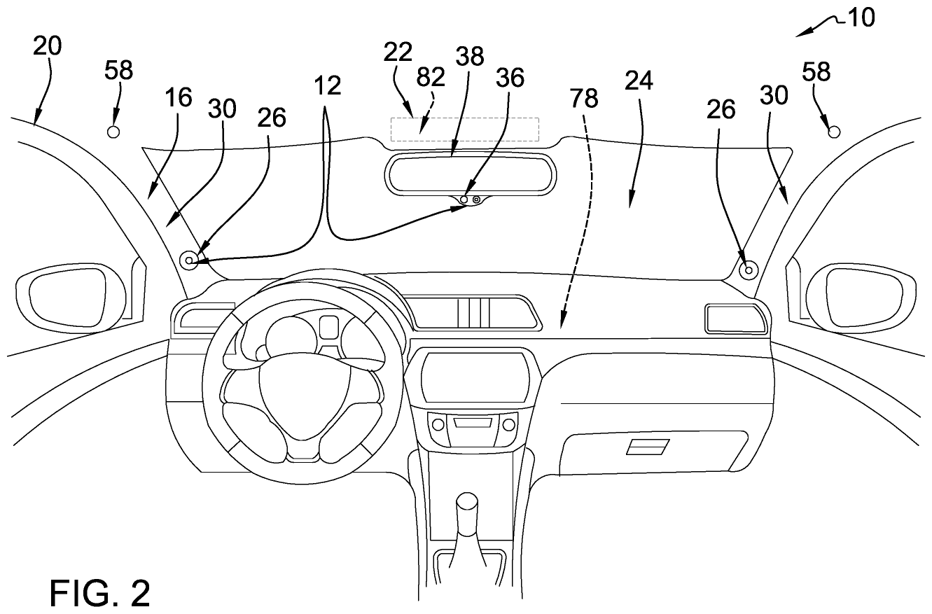

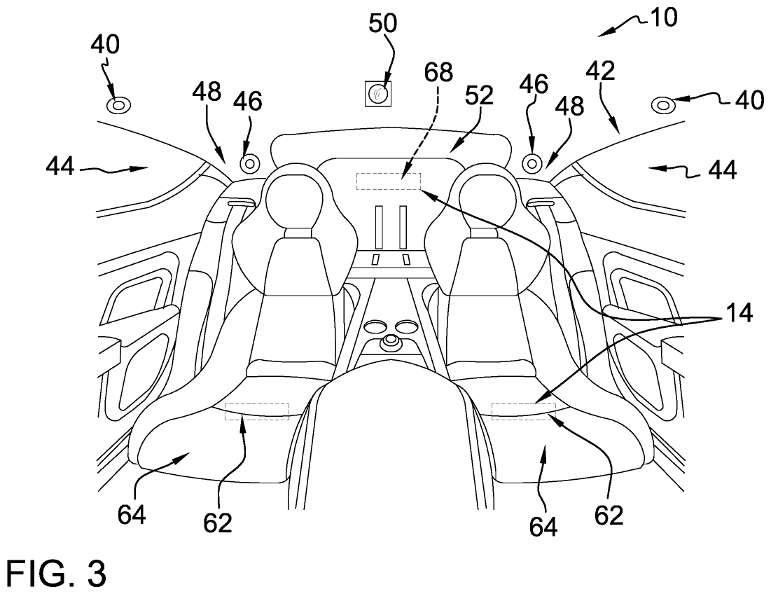

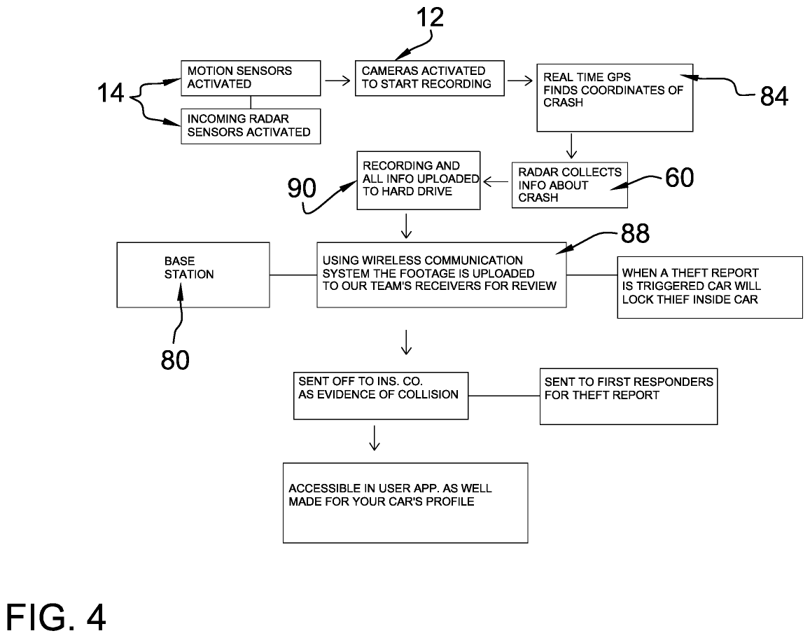

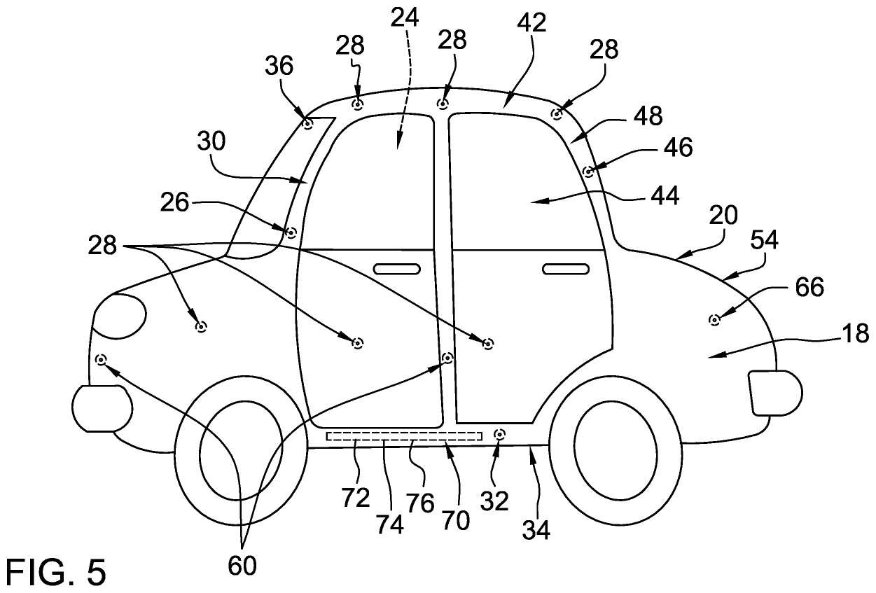

With reference now to the drawings, and in particular to FIGS. 1 through 5 thereof, a new monitoring assembly embodying the principles and concepts of an embodiment of the disclosure and generally designated by the reference numeral 10 will be described.

As best illustrated in FIGS. 1 through 5, the vehicle event monitoring assembly generally comprises a plurality of cameras 12 and a plurality of detectors 14, which are configured to be engageable to interior elements 16 and exterior elements 18 of a vehicle 20, along with a communications and control module 22, which is configured to be engageable to the vehicle 20. A passenger compartment 24 and a 360° area around the vehicle 20 are substantially viewable by the plurality of cameras 12. The plurality of cameras 12 comprises a pair of front cameras 26 and a plurality of panoramic cameras 28. The front cameras 26 are configured to be engaged singly to front support columns 30 of the vehicle 20 and are configured to capture images of the passenger compartment 24. The panoramic cameras 28 are configured to be engageable to the exterior elements 18 of the vehicle 20 and to capture panoramic images substantially covering the 360° area around the vehicle 20.

The plurality of cameras 12 also may comprise a bottom camera 32, which is configured to be engageable to an underside 34 of the vehicle 20 to capture images of the of an area proximate to the underside 34 of the vehicle 20. The plurality of cameras 12 also may comprise a mirror camera 36, which is configured to be engageable to a rearview mirror 38 of the vehicle 20 to capture images of the passenger compartment 24.

The plurality of cameras 12 also may comprise a pair of roof cameras 40, which are configured to be engageable to a roof 42 of the vehicle 20 so that the roof cameras 40 are positioned singly over rear passenger windows 44 of the vehicle 20. The roof cameras 40 are configured to capture images of the passenger compartment 24. The plurality of cameras 12 also may comprise a pair of rear cameras 46, which are configured to be engaged singly to rear support columns 48 of the vehicle 20 to capture images of the passenger compartment 24.

The plurality of cameras 12 also may comprise a center camera 50, which is configured to be mountable to the roof 42 of the vehicle 20 proximate to a rear window 52 of the vehicle 20 and substantially equally distant from the rear support columns 48. The center camera 50 is configured to capture panoramic images of the passenger compartment 24. The present invention anticipates the plurality of cameras 12 being integral to the vehicle 20.

The detectors 14 are configured for one or more of detecting a rollover of the vehicle 20, motion within or occupancy of the passenger compartment 24 and a trunk 54 of the vehicle 20, as well as approach and impact of a second vehicle (not shown). Each of a plurality of remote transceivers 56 is operationally engaged to a respective camera 12 or a respective detector 14.

The plurality of detectors 14 comprises a pair of motion sensors 58 and a plurality of radar emitter and detector devices 60. The motion sensors 58 are configured to be engaged singly to the front support columns 30 of the vehicle 20 to detect motion within the passenger compartment 24. The plurality of radar emitter and detector devices 60 are configured to be engageable to the vehicle 20 to measure distance to, and speed of, approaching vehicles.

The plurality of detectors 14 also may comprise a pair of occupancy sensors 62, which are configured to be engageable to backseats 64 of the vehicle 20 so that a respective occupancy sensor 62 is actuated by a mass of a user positioned on an associated backseat 64. The plurality of detectors 14 also may comprise a trunk thermal sensor 66, which is configured to be engageable the vehicle 20 so that the trunk thermal sensor 66 is positioned within the trunk 54. The trunk thermal sensor 66 is configured to detect a mammal, such as an abduction victim, positioned in the trunk 54.

The plurality of detectors 14 also may comprise a passenger compartment thermal sensor 68, which is configured to be engageable to an interior element 16 of the vehicle so that the passenger compartment thermal sensor 68 is positioned within the passenger compartment 24. The passenger compartment thermal sensor 68 is configured to detect a mammal, such an auto thief, positioned in the passenger compartment 24.

The plurality of detectors 14 also may comprise a rollover sensor 70, which is configured to be engageable to the vehicle 20 to detect a rollover of the vehicle 20. The rollover sensor 70 may comprise an accelerometer 72 and one of an angular rate sensor 74 and a gyroscope 76. The present invention anticipates the plurality of detectors 14 being integral to the vehicle 20. For example, the rollover sensor 70 may be integral to an airbag control module 78 of the vehicle 20.

The communications and control module 22 is operationally engaged to the detectors 14 and the cameras 12. The detectors 14 are enabled to signal the communications and control module 22 of events within and proximate to the vehicle 20, positioning the communications and control module 22 to actuate the cameras 12. The communications and control module 22 is configured to transmit images and parameters of the events to a base station 80.

The communications and control module 22 comprises a microprocessor 82, a first transceiver 84, a second transceiver 86, and a third transceiver 88. The first transceiver 84, the second transceiver 86, and the third transceiver 88 are operationally engaged to the microprocessor 82. The first transceiver 84 is global positioning system enabled and thus is configured to receive coordinates of the vehicle 20 and to relay the coordinates to the microprocessor 82. The second transceiver 86 is communicatively engaged to the plurality of remote transceivers 56 so that each remote transceiver 56 is enabled to communicate images or parameters of the events from an associated camera 12 or an associated detector 14, respectively, to the microprocessor 82 via the second transceiver 86. The third transceiver 88 is configured for wireless communications with the base station 80. The microprocessor 82 is enabled to selectively actuate the third transceiver 88 to transmit the images or parameters of the events to the base station 80.

The communications and control module 22 also may comprise a data storage module 90, which is operationally engaged to the microprocessor 82. The microprocessor 82 is enabled to actuate the data storage module 90 to store the images and the parameters of the events.

In use, the vehicle event monitoring assembly 10 is installed in the vehicle 20 and the vehicle 20 then is operated normally. Should the detectors 14 sense movement in the vehicle 20 or another vehicle approaching, the microprocessor 82 will actuate the plurality of cameras 12 to capture images of the passenger compartment 24 and the 360° area around the vehicle 20. The images and the parameters of the events are sent to the base station 80 for evaluation, with subsequent dispatch of emergency services appropriate for dealing with the events. The present invention is anticipated to be useful for insurance purposes following an accident by providing evidence. The present invention also has potential to identify an abduction via the trunk thermal sensor 66, which would detect a human being positioned in the trunk 54. Another potential use of the vehicle event monitoring assembly 10 is remote locking of doors of the vehicle 20, and potential disablement of the vehicle 20, by the base station 80 upon theft of the vehicle 20. The present invention also anticipates the images and the parameters of the events of the events being accessible to the user on a personal electronic device connectable to the base station 80.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle event monitoring assembly comprising:
a plurality of cameras configured to be engageable to interior elements and exterior elements of a vehicle, such that a passenger compartment and a 360° area around the vehicle are substantially viewable by the plurality of cameras;
a plurality of detectors configured to be engageable to the interior elements and the exterior elements of the vehicle, the detectors being configured for one or more of detecting a rollover of the vehicle, motion within or occupancy of the passenger compartment and a trunk of the vehicle, and approach and impact of a second vehicle; and
a communications and control module configured to be engageable to the vehicle, the communications and control module being operationally engaged to the detectors and the cameras, such that the detectors are enabled for signaling the communications and control module of events within and proximate to the vehicle, positioning the communications and control module for actuating the cameras, wherein the communications and control module is configured for transmitting images and parameters of the events to a base station.

2. The vehicle event monitoring assembly of claim 1, wherein the plurality of cameras of comprises:
a pair of front cameras configured to be engaged singly to front support columns of the vehicle, wherein the front cameras are configured for capturing images of the passenger compartment; and
a plurality of panoramic cameras configured to be engageable to the exterior elements of the vehicle, wherein the panoramic cameras are configured for capturing panoramic images substantially covering the 360° area around the vehicle.

3. The vehicle event monitoring assembly of claim 2, further including the plurality of cameras comprising a bottom camera configured to be engageable to an underside of the vehicle, wherein the bottom camera is configured for capturing images of the of an area proximate to the underside of the vehicle.

4. The vehicle event monitoring assembly of claim 2, further including the plurality of cameras comprising a mirror camera configured to be engageable to a rearview mirror of the vehicle, wherein the mirror camera is configured for capturing images of the passenger compartment.

5. The vehicle event monitoring assembly of claim 2, further including the plurality of cameras comprising a pair of roof cameras configured to be engageable to a roof of the vehicle, such that the roof cameras are positioned singly over rear passenger windows of the vehicle, wherein the roof cameras are configured for capturing images of the passenger compartment.

6. The vehicle event monitoring assembly of claim 2, further including the plurality of cameras comprising a pair of rear cameras configured to be engaged singly to rear support columns of the vehicle, wherein the rear cameras are configured for capturing images of the passenger compartment.

7. The vehicle event monitoring assembly of claim 2, further including the plurality of cameras comprising a center camera configured to be mountable to the roof of the vehicle proximate to a rear window of the vehicle and substantially equally distant from the rear support columns, the center camera being configured for panoramic imaging, wherein the center camera is configured for capturing panoramic images of the passenger compartment.

8. The vehicle event monitoring assembly of claim 1, wherein the plurality of detectors comprises:
a pair of motion sensors configured to be engaged singly to the front support columns of the vehicle, wherein the motion sensors are configured for detecting motion within the passenger compartment; and
a plurality of radar emitter and detector devices configured to be engageable to the vehicle, wherein the radar emitter and detector devices are configured for measuring distance to and speed of approaching vehicles.

9. The vehicle event monitoring assembly of claim 8, further including the plurality of detectors comprising a pair of occupancy sensors configured to be engageable to backseats of the vehicle, a respective occupancy sensor being actuated by a mass of a user positioned on an associated backseat.

10. The vehicle event monitoring assembly of claim 8, further including the plurality of detectors comprising a trunk thermal sensor configured to be engageable the vehicle, such that the trunk thermal sensor is positioned within the trunk, wherein the trunk thermal sensor is configured for detecting a mammal positioned in the trunk.

11. The vehicle event monitoring assembly of claim 8, further including the plurality of detectors comprising a passenger compartment thermal sensor configured to be engageable to an interior element of the vehicle, such that the passenger compartment thermal sensor is positioned within the passenger compartment, wherein the passenger compartment thermal sensor is configured for detecting a mammal positioned in the passenger compartment.

12. The vehicle event monitoring assembly of claim 8, further including the plurality of detectors comprising a rollover sensor configured to be engageable to the vehicle, wherein the rollover sensor is configured for detecting a rollover of the vehicle.

13. The vehicle event monitoring assembly of claim 12, wherein the rollover sensor is integral to an airbag control module of the vehicle.

14. The vehicle event monitoring assembly of claim 12, wherein the rollover sensor comprises an accelerometer and one of an angular rate sensor and a gyroscope.

15. The vehicle event monitoring assembly of claim 1, further including:
a plurality of remote transceivers, each remote transceiver being operationally engaged to a respective camera or a respective detector; and
the communications and control module comprising:
a microprocessor,
a first transceiver operationally engaged to the microprocessor, the first transceiver being global positioning system enabled, wherein the first transceiver is configured for receiving coordinates of the vehicle and for relaying the coordinates to the microprocessor,
a second transceiver operationally engaged to the microprocessor, the second transceiver being communicatively engaged to the plurality of remote transceivers, such that each remote transceiver is enabled for communicating images or parameters of the events from an associated camera or an associated detector, respectively, to the microprocessor via the second transceiver, and
a third transceiver operationally engaged to the microprocessor and being configured for wireless communications with the base station, such that the microprocessor is enabled for selectively actuating the third transceiver for transmitting the images or parameters of the events to the base station.

16. The vehicle event monitoring assembly of claim 14, further including a data storage module operationally engaged to the microprocessor, such that the microprocessor is enabled for actuating the data storage module for storing the images and the parameters of the events.

17. A vehicle event monitoring system comprising:
a vehicle;
a base station configured for wireless communication;
a plurality of cameras engaged to interior elements and exterior elements of the vehicle, such that a passenger compartment and a 360° area around the vehicle are substantially viewable by the plurality of cameras;
a plurality of detectors engaged to the interior elements and the exterior elements of the vehicle, the detectors being configured for one or more of detecting a rollover of the vehicle, motion within or occupancy of the passenger compartment and a trunk of the vehicle, and approach and impact of a second vehicle; and
a communications and control module engaged to the vehicle, the communications and control module being operationally engaged to the detectors and the cameras, such that the detectors are enabled for signaling the communications and control module of events within and proximate to the vehicle, positioning the communications and control module for actuating the cameras, wherein the communications and control module is configured for transmitting images and parameters of the events to the base station.

18. A vehicle event monitoring assembly comprising:
a plurality of cameras configured to be engageable to interior elements and exterior elements of a vehicle, such that a passenger compartment and a 360° area around the vehicle are substantially viewable by the plurality of cameras, the plurality of cameras comprising:
a pair of front cameras configured to be engaged singly to front support columns of the vehicle, wherein the front cameras are configured for capturing images of the passenger compartment,
a mirror camera configured to be engageable to a rearview mirror of the vehicle, wherein the mirror camera is configured for capturing images of the passenger compartment,
a pair of roof cameras configured to be engageable to a roof of the vehicle, such that the roof cameras are positioned singly over rear passenger windows of the vehicle, wherein the roof cameras are configured for capturing images of the passenger compartment,
a pair of rear cameras configured to be engaged singly to rear support columns of the vehicle, wherein the rear cameras are configured for capturing images of the passenger compartment,
a center camera configured to be mountable to the roof of the vehicle proximate to a rear window of the vehicle and substantially equally distant from the rear support columns, the center camera being configured for panoramic imaging, wherein the center camera is configured for capturing panoramic images of the passenger compartment,
a bottom camera configured to be engageable to an underside of the vehicle, wherein the bottom camera is configured for capturing images of the of an area proximate to the underside of the vehicle, and
a plurality of panoramic cameras configured to be engageable to the exterior elements of the vehicle, wherein the panoramic cameras are configured for capturing panoramic images substantially covering the 360° area around the vehicle;
a plurality of detectors configured to be engageable to the interior elements and the exterior elements of the vehicle, the detectors being configured for one or more of detecting a rollover of the vehicle, motion within or occupancy of the passenger compartment and a trunk of the vehicle, and approach and impact of a second vehicle, the plurality of detectors comprising:
a pair of occupancy sensors configured to be engageable to backseats of the vehicle, a respective occupancy sensor being actuated by a mass of a user positioned on an associated backseat,
a trunk thermal sensor configured to be engageable the vehicle, such that the trunk thermal sensor is positioned within the trunk, wherein the trunk thermal sensor is configured for detecting a mammal positioned in the trunk,
a passenger compartment thermal sensor configured to be engageable to an interior element of the vehicle, such that the passenger compartment thermal sensor is positioned within the passenger compartment, wherein the passenger compartment thermal sensor is configured for detecting a mammal positioned in the passenger compartment,
a rollover sensor configured to be engageable to the vehicle, wherein the rollover sensor is configured for detecting a rollover of the vehicle, the rollover sensor being integral to an airbag control module of the vehicle, the rollover sensor comprising an accelerometer and one of an angular rate sensor and a gyroscope,
a pair of motion sensors configured to be engaged singly to the front support columns of the vehicle, wherein the motion sensors are configured for detecting motion within the passenger compartment, and
a plurality of radar emitter and detector devices configured to be engageable to the vehicle, wherein the radar emitter and detector devices are configured for measuring distance to and speed of approaching vehicles;
a plurality of remote transceivers, each remote transceiver being operationally engaged to a respective camera or a respective detector; and
a communications and control module configured to be engageable to the vehicle, the communications and control module being operationally engaged to the detectors and the cameras, such that the detectors are enabled for signaling the communications and control module of events within and proximate to the vehicle, positioning the communications and control module for actuating the cameras, wherein the communications and control module is configured for transmitting images and parameters of the events to a base station, the communications and control module comprising:
a microprocessor,
a first transceiver operationally engaged to the microprocessor, the first transceiver being global positioning system enabled, wherein the first transceiver is configured for receiving coordinates of the vehicle and for relaying the coordinates to the microprocessor,
a second transceiver operationally engaged to the microprocessor, the second transceiver being communicatively engaged to the plurality of remote transceivers, such that each remote transceiver is enabled for communicating images or parameters of the events from an associated camera or an associated detector, respectively, to the microprocessor via the second transceiver,
a third transceiver operationally engaged to the microprocessor and being configured for wireless communications with the base station, such that the microprocessor is enabled for selectively actuating the third transceiver for transmitting the images or parameters of the events to the base station, and
a data storage module operationally engaged to the microprocessor, such that the microprocessor is enabled for actuating the data storage module for storing the images and the parameters of the events.
